(19) United States
(12) Patent Application Publication
(10) Pub. No.: US 2022/0290735 A1
(43) Pub. Date: Sep. 15, 2022

(54) NOISE ABATEMENT STRUCTURE FOR SYSTEM FOR REDUCING TORSIONAL VIBRATION ON A ROTARY SHAFT

(71) Applicant: Litens Automotive Partnership, Woodbridge (CA)

(72) Inventors: Geoffrey HODGSON, Aurora (CA); Christopher GIFF, Maple (CA); Geoffrey LAWRENCE, Keswick (CA); Vladmir SAMOILOV, Vaughan (CA)

(21) Appl. No.: 17/754,153

(22) PCT Filed: Sep. 28, 2020
(86) PCT No.: PCT/CA2020/051293

§ 371 Date: Mar. 25, 2022

Related U.S. Application Data
(60) Provisional application No. 62/907,374, filed on Sep. 27, 2019.
(60) Provisional application No. 63/053,433, filed on Jul. 17, 2020.

(51) Int. Cl. F16F 15/134; F16H 55/36; F16D 3/12; F02B 67/06

(52) U.S. Cl. CPC F16F 15/13469; F16H 55/36; F16D 3/12; F02B 67/06; F16H 2055/366; B60K 2025/022

(57) ABSTRACT

In an aspect, a system is provided for reducing torsional vibrations for an engine having a crankshaft. The system includes an isolation device, which includes a shaft adapter that is mounted to the crankshaft, a pulley that is rotatably mounted to the shaft adapter, and at least one isolation spring that resiliently transfers torque between the pulley and the shaft adapter. The system further includes a torsional vibration damper that is mountable to the crankshaft. A noise generation space extends axially between the isolation device and the torsional vibration damper. The system further includes a noise abatement ring that extends axially from one of the isolation device and the torsional vibration damper towards the other of the isolation device and the torsional vibration damper, and at least partially radially encloses at least a portion of the noise generation space.

### CROSS-REFERENCE TO RELATED APPLICATIONS

This application claims the benefit of U.S. provisional application No. 63/053,433, filed Jul. 17, 2020, and U.S. provisional application No. 62/907,374, filed Sep. 27, 2019, the contents of both of which are incorporated herein by reference in their entirety.

### FIELD OF THE DISCLOSURE

This application relates to a noise abatement structure for reducing noise emanating from an isolation device on a rotary shaft in a vehicle, and reducing noise emanating from an isolation device on an engine-driven crankshaft in a vehicle.

### BACKGROUND

Accessory drive belts are used in vehicles to drive accessories such as air conditioning compressors and water pumps. The accessory drive belt is driven by the engine crankshaft and transmits power therefrom to the accessories. However, engines impart torsional vibrations to the crankshaft due to the reciprocating movement of the pistons of the engine. Two elements that are provided on the crankshaft to attenuate the torsional vibrations, namely an isolation device and a torsional vibration damper (TVD). In some instances an unacceptable amount of noise emanates from the isolation device and reaches the passenger cabin of the vehicle.

It would be desirable to provide a solution that reduces the amount of noise emanating from the isolation device.

### SUMMARY

In a first aspect, a system is provided for reducing torsional vibrations for an engine having a crankshaft. The system includes an isolation device mountable on the crankshaft, and which is rotatable thereon about an axis. The isolation device includes a shaft adapter that is mounted to the crankshaft, a pulley that is rotatably mounted to the shaft adapter, and at least one isolation spring that resiliently transfers torque between the pulley and the shaft adapter. The system further includes a torsional vibration damper that is mountable to the crankshaft. A noise generation space extends axially between the isolation device and the torsional vibration damper. The system further includes a noise abatement ring that extends axially from one of the isolation device and the torsional vibration damper towards the other of the isolation device and the torsional vibration damper, and at least partially radially encloses at least a portion of the noise generation space. The noise abatement ring extends to within a selected distance of the other of the isolation device and the torsional vibration damper. In some embodiments the selected distance may be about 2 mm.

In another aspect, a system is provided for reducing torsional vibrations for an engine having a crankshaft. The system includes an isolation device mountable on the crankshaft, and which is rotatable thereon about an axis. The isolation device includes a shaft adapter that is mounted to the crankshaft, a rotary transfer member that is rotatably mounted to the shaft adapter and which is shaped to engage one of an endless drive member or a gear, and at least one isolation spring that resiliently transfers torque between the pulley and the shaft adapter. A noise generation space extends axially between the isolation device and the torsional vibration damper. The system further includes a noise abatement ring that extends axially from one of the isolation device and the torsional vibration damper towards the other of the isolation device and the torsional vibration damper, and at least partially radially encloses at least a portion of the noise generation space. The noise abatement ring extends to within a selected distance of the other of the isolation device and the torsional vibration damper. In some embodiments the selected distance may be about 2 mm.

### BRIEF DESCRIPTION OF DRAWINGS

The foregoing and other aspects of the disclosure will be better understood with reference to the attached drawings, wherein:

FIG. 1 is an elevation view of a vehicle engine with an accessory drive system, in accordance with an embodiment of the present disclosure.

FIG. 2 is a perspective view of an isolation device and a torsional vibration damper (TVD) with a noise abatement structure for the vehicle engine shown in FIG. 1.

FIG. 3A is a perspective exploded view of the isolation device and the TVD with the noise abatement structure shown in FIG. 2.

FIG. 3B is another perspective exploded view of the isolation device and the TVD with the noise abatement structure shown in FIG. 2.

FIG. 4 is a sectional elevation view of a portion of the isolation device and the TVD with the noise abatement structure shown in FIG. 2.

FIG. 5 is a sectional elevation view of a portion of an isolation device and a TVD with a noise abatement structure in accordance with another embodiment of the present disclosure.

FIG. 6 is a sectional elevation view of a portion of an isolation device and a TVD with a noise abatement structure in accordance with another embodiment of the present disclosure.

FIG. 7 is a sectional elevation view of a portion of an isolation device and a TVD with a noise abatement structure in accordance with another embodiment of the present disclosure.

FIG. 8 is a sectional elevation view of a portion of an isolation device and a TVD with a noise abatement structure in accordance with another embodiment of the present disclosure.

FIG. 9 is a sectional elevation view of a portion of an isolation device and a TVD with a noise abatement structure in accordance with another embodiment of the present disclosure.

FIG. 10 is a graph illustrating noise levels for some types of noise abatement structure shown and described herein.

### DETAILED DESCRIPTION

For simplicity and clarity of illustration, where considered appropriate, reference numerals may be repeated among the drawings to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the drawings and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

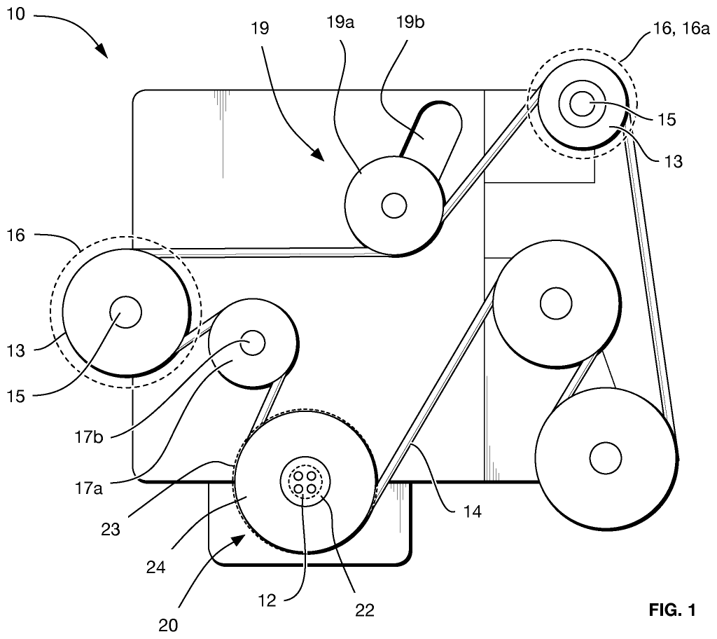

Reference is made to FIG. 1, which shows an engine 10 for a vehicle. The engine 10 includes a crankshaft 12 which drives an endless drive element, which may be, for example, a belt 14. Via the belt 14, the engine 10 drives a plurality of accessories 16 (shown in dashed outlines), such as an air conditioning compressor (shown individually at 16a) and a motor/generator unit (MGU) (shown individually at 16b). The belt 14 may thus be referred to as an accessory drive belt 14. Each accessory 16 includes an accessory shaft 15 with a pulley 13 thereon, which is driven by the belt 14. Additionally, shown in the present embodiment is an idler pulley shown at 17a on an idler shaft 17b, and a tensioner pulley 19a rotatably mounted on a tensioner arm 19b, which form part of a belt tensioner 19. The functions of the idler pulley 17a and the belt tensioner 19 are well known to one of skill in the art.

An isolation device 20 is provided on the crankshaft 12 instead of a simple pulley, to transmit torque between the crankshaft 12 and the belt 14. The isolation device 20 may be an isolator which includes one or more isolation springs to transmit torque while attenuating torsional vibration, or alternatively it may be a decoupler, which includes one or more isolation springs in addition to a one-way clutch, as is known in the art.

Additionally, a TVD 21 is provided on the crankshaft 12, to attenuate other torsional vibrations in the crankshaft 12, as is known in the art. The TVD 21 is shown as a dashed outline only in FIG. 1, so as not to obscure components that are behind it in the view shown.

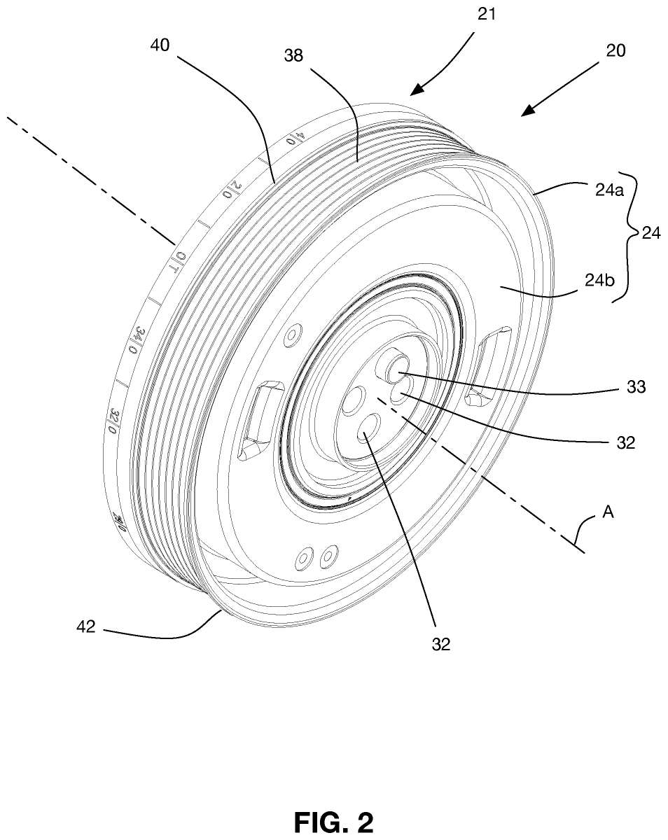

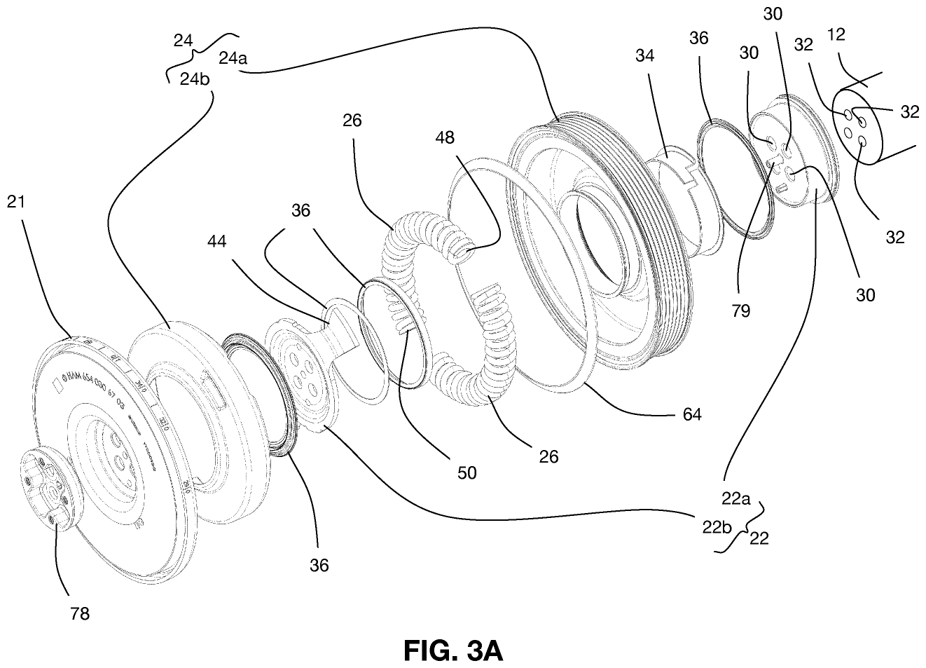

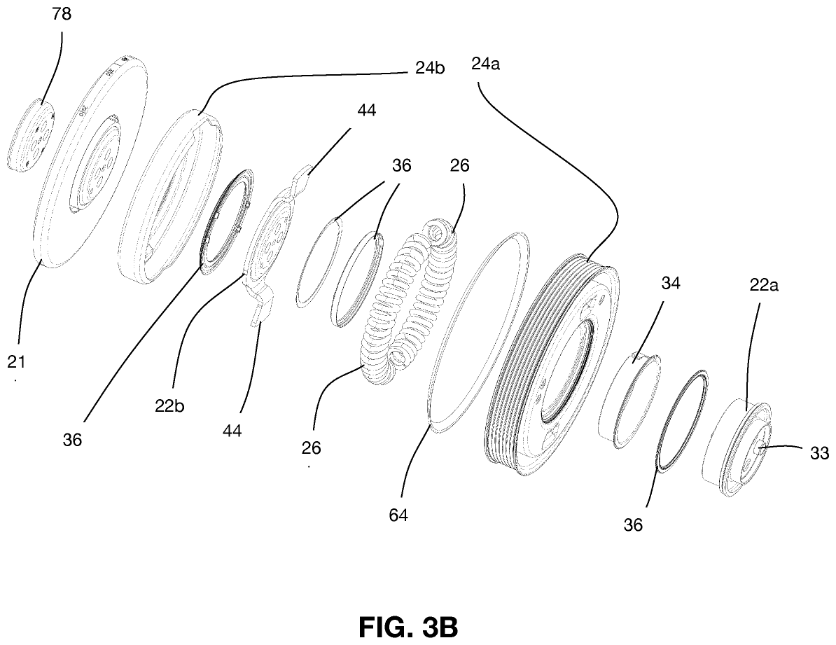

The isolation device 20 and TVD 21 are shown in more detail in FIGS. 2, 3A, 3B and 4. The isolation device 20 includes a shaft adapter 22 that defines an axis A, a pulley 24 that is rotatably mounted to the shaft adapter 22 about the axis A, and at least one isolation spring 26. The shaft adapter 22 is shaped to be mounted to the crankshaft 12, and is shown as being mounted to the crankshaft 12 in FIG. 1. In the example shown, the shaft adapter 22 includes four fastener pass-through apertures 30 that align with four fastener apertures 32 in the end of the crankshaft 12 (FIG. 3A) for receiving mounting fasteners (one of which is shown in FIGS. 2 and 3B) to hold the shaft adapter 22 and the isolation device 20 on the crankshaft 12.

In the example embodiment shown, the pulley 24 includes a main pulley portion 24a and a pulley cover 24b that is fixedly mounted to the main pulley portion 24a to enclose a spring chamber 30. The pulley 24 is rotatably mounted to the shaft adapter 22 by means of a bushing 34 that is provided therebetween. Suitable seal members 36 may be provided as appropriate to protect dirt and other contaminants from migrating between the bushing 34 and the pulley 24 or the shaft adapter 22.

The pulley 24 includes a belt engagement surface 38 that is shaped to engage the belt 14 so as to transmit torque to the belt 14. The belt engagement 38 may have a V pattern in instances where the belt 14 is a poly-V belt. The pulley 24 further includes a first pulley flange 40 on a first side of the belt engagement surface 38 and a second pulley flange 42 on a second side of the belt engagement surface 38.

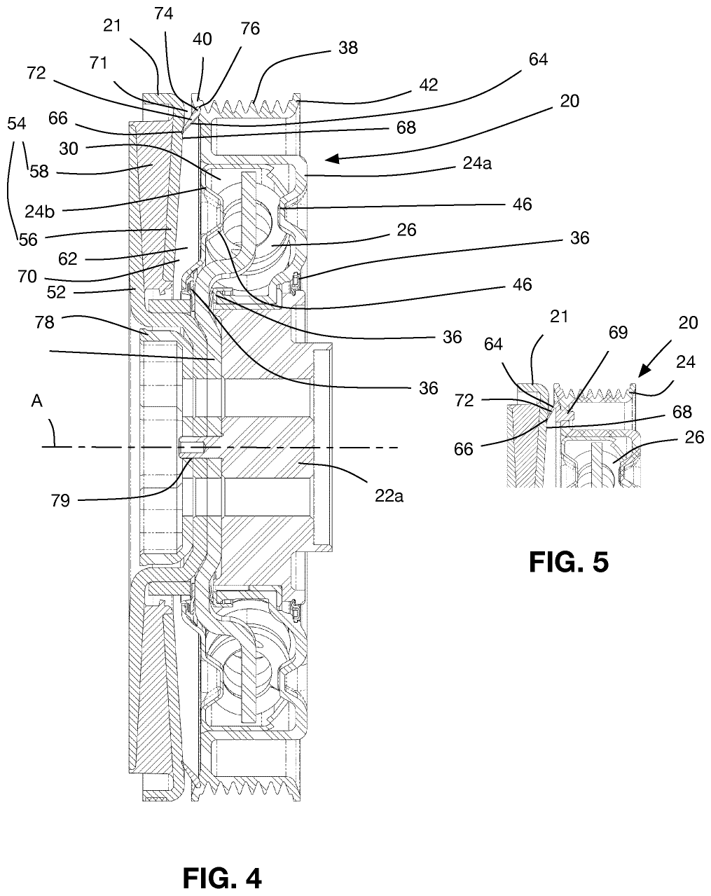

The at least one isolation spring 26 resiliently transfers torque between the shaft adapter 22 and the pulley 24. In the embodiment the shaft adapter 22 includes a shaft mounting portion 22a and a driver plate 22b with spring engagement arms 44 thereon. The pulley 24 includes spring engagement lugs 46 thereon, which are seen best in FIG. 4. Each of the at least one isolation spring 26 may be an arcuate helical compression spring having a first end 48 that is engaged with either the driver plate 22b or the spring engagement lugs 46, and a second end 50 that is engaged with the other of the driver plate 22b and the spring engagement lugs 46, so as to transfer torque between the shaft adapter 22 and the pulley 24. In the example shown there are two isolation springs 26, however in other embodiments there could be more or fewer isolation springs 26. Furthermore, the at least one isolation spring 26 could be a different type of spring, such as a helical torsion spring, or an elastomeric member.

During operation of the engine 10 there will be relative movement between the pulley 24 and the crankshaft 12 due to changes in the torque being transmitted at any given time.

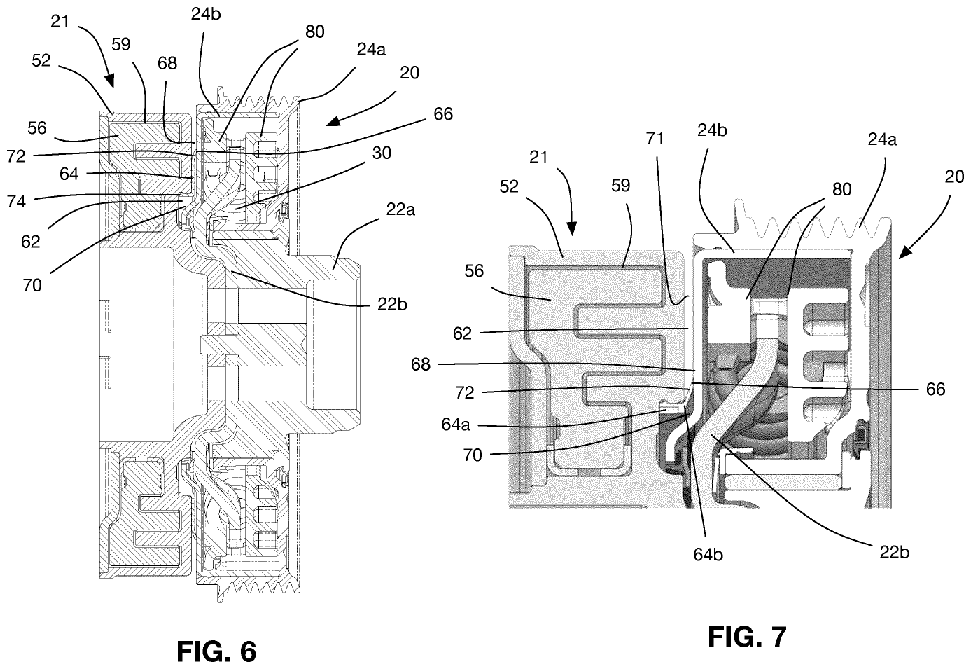

The TVD 21 is also mountable to the crankshaft 12. The TVD 21 may be any suitable type of TVD. As can be seen best in FIG. 4, the TVD 21 includes a hub 52 and, radially outside the hub 52, a torsional vibration structure 54 that is supported on the hub 52. The torsional vibration structure 54 includes an inertia member 56 and, in the embodiment shown, an elastic member 58 through which the inertia member 56 is mounted to the hub 52, as is known in the art. Instead of the elastic member, the torsional vibration structure 54 could include a fluid chamber between the hub 52 and the inertia member 56. FIG. 6 shows an embodiment in which a fluid chamber 59 is provided between the hub 52 and the inertia member 56. The fluid chamber 59 contains a viscous damping fluid 60 as is known in the art. It will be understood that the shape of the hub 52 and the inertia member 56 are different in the embodiment shown in FIG. 6 than in the embodiment shown in FIG. 4.

As best shown in FIG. 4, a noise generation space 62 extends axially between the isolation device 20 and the TVD 21. During operation of the engine 10, as the isolation springs 26 engage with either the arms 44 on the driver plate 22b or with the lugs 46 on the pulley 24, a noise is generated. The noise can emanate from the noise generation space 62 between the TVD 21 and the isolation device 20. In order to reduce the likelihood that the noise can be heard from within the passenger cabin of the vehicle in which the engine 10 sits, a noise abatement ring 64 is provided. The noise abatement ring 64 extends axially from one of the isolation device 20 and the TVD 21 towards the other of the isolation device 20 and the TVD 21, and at least partially radially encloses at least a portion of the noise generation space 62. The noise abatement ring 64 extends to within a selected distance of the other of the isolation device 20 and the TVD 21.

In the embodiment shown, the noise abatement ring 64 is mounted to the isolation device 20 and extends towards the TVD 21, though in the embodiment shown in FIG. 6, the noise abatement ring 64 is mounted to the TVD 21 and extends towards the isolation device 20.

The applicant has learned that, by extending the noise abatement ring 64 to be sufficiently proximate to the other of the isolation device 20 and the TVD 21, the noise abatement ring 64 attenuates noise sufficiently so as to be substantially inaudible by an average person in the passenger cabin.

In the embodiment shown, the noise abatement ring 64 extends all the way to the other of the isolation device 20 and the TVD 21. More specifically, the noise abatement ring 64 includes a first engagement surface 66, and the other of the isolation device 20 and the TVD 21 (the TVD 21 in this instance) includes a second engagement surface 68 that is engaged by the first engagement surface 66.

In the example shown, the first engagement surface 66 is made from a first material that is softer than a second material from which the second engagement surface 68 is made. In the example shown, the first engagement surface 66 is made from a suitable Nylon material such as PA 46. The second engagement surface 68 is, in the example shown, on the inertia member 56, and may be made from steel or some other suitable metal.

In the embodiment shown, the entire noise abatement ring 64 may be made from a single material such as PA46. In other embodiments, discussed further below, the noise abatement ring 64 may include several components that are made from different materials.

The noise abatement ring 64 extends to within a selected distance of the other of the isolation device 20 and the TVD 21. For example, the noise abatement ring 64 may extend to within 2 mm of the other of the isolation device 20 and the TVD 21. In some embodiments the noise abatement ring 64 may extend to within 1 mm of the other of the isolation device 20 and the TVD 21. In the embodiment shown in FIG. 4, the noise abatement ring extends all the way to the other of the isolation device 20 and the TVD 21. The applicant has tested the performance of the noise abatement ring 64 at different distances from the other of the isolation device 20 and the TVD 21, and has found that by approaching to about 2 mm can be advantageous in that there is little wear on the noise abatement ring 64 over time, even with any axial movement that might occur between the isolation device 20 and the TVD 21 over time. Approaching to about 1 mm can be advantageous in that there may be some wear on the noise abatement ring 64 but there it is a relatively small amount and there is an improvement in the noise abatement relative to approaching to about 2 mm.

By extending all the way to the other of the isolation device 20 and the TVD 21, the noise abatement ring 64 fully radially encloses at least a portion of the noise generation space 62. In FIG. 4, the noise abatement ring 64 is shown enclosing a portion shown at 70 of the noise generation space 62, and only a very small portion of the noise generation space 62 is outside of the noise abatement ring 64 (and is shown at 71). This provides increased noise abatement as opposed to an embodiment in which the noise abatement ring 64 extends towards but does not contact the other of the isolation device 20 and the TVD 21.

As can be seen in FIG. 4, proximal to the first engagement surface 66, the noise abatement ring includes a flex portion 72 that extends radially and axially, at an oblique angle to the axis A. The flex portion 72 in the embodiment shown in FIG. 4, extends radially inwardly and axially. In other embodiments (such as the embodiment shown in FIG. 6) the flex portion 72 extends radially outwardly and axially. Extending radially outwardly and axially is advantageous in that it means that the noise abatement ring 64 radially encloses a greater fraction of the noise generation space 62, relative to an embodiment in which the flex portion 72 extends radially inwardly and axially.

The noise abatement ring may be connected at its proximal end (shown at 74) to the pulley 24 by any suitable means. In the embodiment shown in FIG. 4, the noise abatement ring 64 extends from the first pulley flange 40. A recess 76 may be provided in the first pulley flange 40 that is shaped to snuggly receive the proximal end 74. Optionally, an adhesive or the like may be employed to assist in holding the noise abatement ring 64 in place. Also optionally, the rigidity of the noise abatement ring 64 may be sufficient to hold itself in place in the recess 76. Underscores may be provided in the noise abatement ring near the proximal end 74 so as to facilitate flexing of the noise abatement ring 64 sufficiently for insertion into the recess 76.

It will be noted that at least a portion of the spring chamber 30 axially faces the portion of the noise generation space 62 that is at least partially enclosed by the noise abatement ring 64. It is theorized that, as a result, improved noise abatement is provided relative to an embodiment in which none of the spring chamber 30 axially faces the portion of the noise generation space 62 that is at least partially enclosed by the noise abatement ring 64. In the embodiment shown in FIG. 4, the entire spring chamber 30 axially faces the portion of the noise generation space 62 that is at least partially enclosed by the noise abatement ring 64. By contrast, in the embodiments shown in FIGS. 6 and 7, only a portion of the spring chamber 30 axially faces the portion of the noise generation space 62 that is at least partially enclosed by the noise abatement ring 64.

In the embodiment shown in FIG. 4, the TVD 21 and a retainer 78 mount to a projection 79 on the shaft adapter 22, thereby mounting the TVD 21 indirectly to the crankshaft 12. However, it is alternatively possible to mount the TVD 21 directly to the crankshaft 12. Another seal member 36 is provided between the TVD hub 52 and the driver plate 22b.

The embodiment shown in FIG. 5, may be similar to the embodiment shown in FIG. 4, except that in the embodiment shown in FIG. 5, the noise abatement ring 64 includes several plugs 69 spaced circumferentially apart that engage in apertures in the wall of the pulley 24, in order to capture the noise abatement ring 64 to the pulley 24, instead of providing a recess to hold the proximal end 74 of the noise abatement ring 64.

FIG. 6 shows an alternative embodiment as described to some extent above. In the embodiment shown in FIG. 6, the noise abatement ring 64 is connected to the hub 52 of the TVD 21 and extends radially outward therefrom. The noise abatement ring 64 extends all the way to engage the isolation device 20. In the embodiment shown, the second engagement surface 68 is on the pulley 24.

Also, as noted above, the flex portion 72 of the noise abatement ring 64 extends radially outwardly and axially instead of radially inwardly and axially.

In the embodiment shown in FIG. 6, the noise abatement ring 64 is made from a single material, such as, for example, a suitable Nylon.

In addition to employing a viscous TVD, another difference in the embodiment shown in Figure as compared to the embodiment shown in FIGS. 2-5 is that the pulley 24 includes a separate spring shell 80 therein, that holds the isolation springs 26. The spring shell 80 may be made from a polymeric material, as is known in the art. It will be understood however, that the embodiment in FIGS. 2-4 could employ a viscous TVD and/or a spring shell similar to that which are shown in FIG. 6.

FIG. 7 shows an embodiment which is similar to FIG. 6, but which employs a noise abatement ring 64 that is made from a plurality of elements, including a first ring element 64a that is made from a first material and a second ring element 64b that is made from a second material that is softer than the first material. The first ring element 64a may be made from a metal such as steel or aluminum. The second ring element 64b may be made from a polymeric material, such as a suitable Nylon. The second ring element 64b is distal to the first ring element 64a, relative to the torsional vibration damper 21 (i.e. relative to the component to which the noise abatement ring 64 is mounted to). As can be seen, the flex portion 72 in FIG. 7 extends radially outwards and axially.

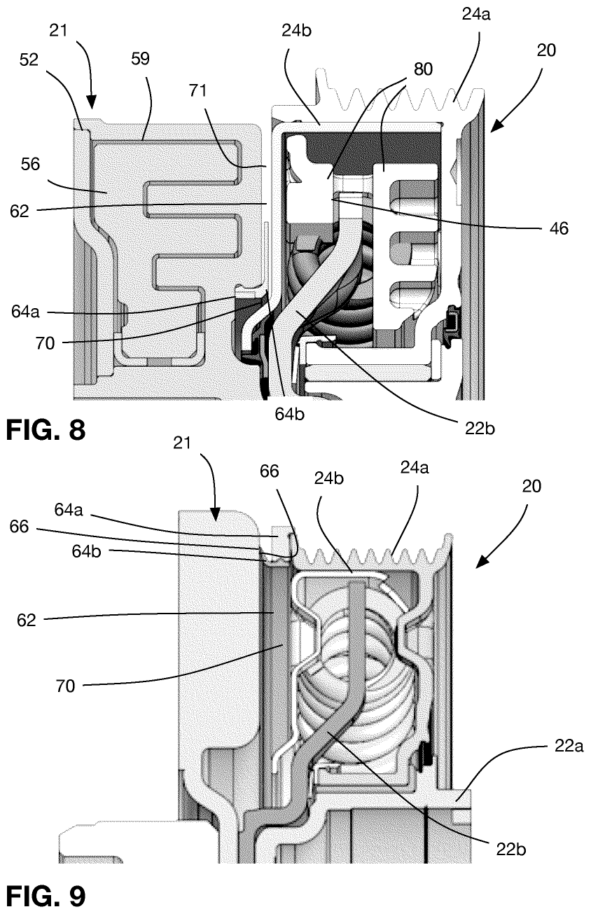

FIG. 8 shows another embodiment that is similar to FIG. 7 in that it employs a noise abatement ring 64 that includes a first ring element 64a and a second ring element 64b. In the embodiment shown in FIG. 8 however, the second ring element 64b extends up radially from its proximal end 74, and does not engage the isolation device 20.

FIG. 9 shows another embodiment, that is similar to the embodiment shown in FIG. 4, but which employs a noise abatement ring 64 that includes a first ring element 64a and a second ring element 64b. In the embodiment shown in FIG. 9 however, the first ring element 64a extends axially towards the TVD 21, to cover some of the noise abatement space 62 not already covered by the pulley 24 itself, and the second ring element 64b extends the rest of the way axially (and up radially) to engage the TVD 21. In the embodiment shown in FIG. 9, the first ring element 64a extends to about 2 mm from the TVD 21, and the second ring element 64b extends the rest of the way.

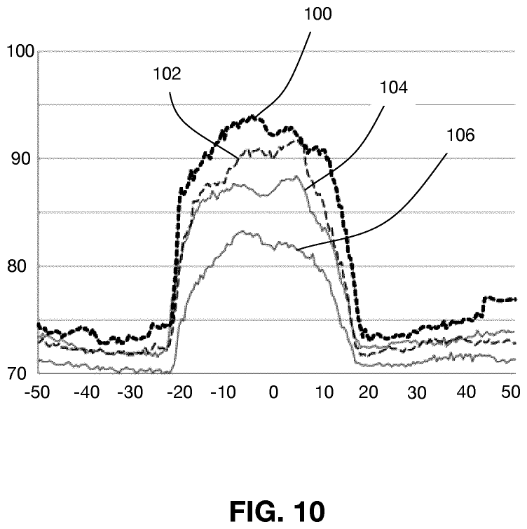

FIG. 10 is a graph that compare the performance of some of the noise abatement rings 64 shown and described herein. The Y axis in FIG. 10 is the noise level in decibels. The test setup employed a microphone 20 cm away from the isolation device 20. The X axis was the torque transmitted through the crankshaft 12. Curve 100 in the graph in FIG. 10 shows the noise level of the TVD 21 and the isolation device 20 when there is no noise abatement ring 64 mounted therebetween. Curve 102 shows the noise level for the embodiment shown in FIG. 9, but with no second ring element 64b provided, and wherein there is a 2 mm gap between the first ring element and the TVD 21. Curve 104 shows the noise level for the embodiment shown in FIG. 9, but with no second ring element 64b provided, and wherein there is a 1 mm gap between the first ring element and the TVD 21. Curve 106 shows the noise level for the embodiment shown in FIG. 9, wherein both the first and second ring elements 64a and 64b are provided, wherein there is engagement between the noise abatement ring 64 and the TVD 21. It will be noted that, the noise level that results by providing both the first and second ring elements 64a and 64b is lower than if the TVD were removed from the test setup and only the isolation device 20 was present on the crankshaft.

The pulley 24 shown in the figures is merely an example of a rotary transfer member that could be provided in the isolation device 20. In other embodiments, the rotary transfer member could be sprocket that engages a timing chain. As can be seen, the belt shown in the figures is merely an example of a suitable type of endless drive member, while the aforementioned timing chain is another example of a suitable type of endless drive member. In yet another embodiment, the rotary transfer member could be a gear that engages further gears.

In some embodiments it is possible that a liquid may be provided in the portion 70 of the noise generation space 62 that is radially enclosed, particularly if the noise abatement ring 64 engages the other of the isolation device 20 and the TVD 21.

Those skilled in the art will appreciate that the embodiments disclosed herein can be modified or adapted in various other ways whilst still keeping within the scope of the appended claims.

What is claimed is:

1. A system for reducing torsional vibrations for an engine having a crankshaft, comprising:
an isolation device mountable on the crankshaft, and which is rotatable thereon about an axis, wherein the isolation device includes a shaft adapter that is mounted to the crankshaft, a pulley that is rotatably mounted to the shaft adapter, and at least one isolation spring that resiliently transfers torque between the pulley and the shaft adapter;
a torsional vibration damper that is mountable to the crankshaft, wherein a noise generation space extends axially between the isolation device and the torsional vibration damper; and
a noise abatement ring that extends axially from one of the isolation device and the torsional vibration damper towards the other of the isolation device and the torsional vibration damper, and at least partially radially encloses at least a portion of the noise generation space, wherein the noise abatement ring extends to within 2 mm of the other of the isolation device and the torsional vibration damper.

2. A system as claimed in claim 1, wherein the noise abatement ring extends all the way to the other of the isolation device and the torsional vibration damper.

3. A system as claimed in claim 2, wherein the noise abatement ring includes a first engagement surface and the other of the isolation device and the torsional vibration damper includes a second engagement surface that is engaged by the first engagement surface, wherein the first engagement surface is made from a first material that is softer than a second material from which the second engagement surface is made.

4. A system as claimed in claim 1, wherein the noise abatement ring includes a first ring element that is made from a first material and a second ring element that is made from a second material that is softer than the first material, and wherein the second ring element is distal to the first ring element, relative to the one of the isolation device and the torsional vibration damper.

5. A system as claimed in claim 4, wherein the second ring element is made from a polymeric material.

6. A system as claimed in claim 4, wherein the first ring element is made from a metal.

7. A system as claimed in claim 1, wherein the torsional vibration damper includes a hub and, radially outside the hub, a torsional vibration structure that is supported on the hub, wherein the torsional vibration structure includes an inertia member and one of a fluid chamber containing viscous damping fluid or an elastic member, and wherein the noise abatement ring is connected to the hub and extends radially outward therefrom.

8. A system as claimed in claim 1, wherein the noise abatement ring further includes a first engagement surface that engages the other of the isolation device and the torsional vibration damper, wherein proximal to the first engagement surface, the noise abatement ring includes a flex portion that extends radially and axially, at an oblique angle to the axis.

9. A system as claimed in claim 8, wherein the flex portion extends radially outwardly and axially.

10. A system as claimed in claim 1, wherein the noise abatement ring extends to within 1 mm from the other of the isolation device and the torsional vibration damper.

11. A system as claimed in claim 1, wherein the isolation device includes a spring chamber that contains the at least one isolation spring, and wherein at least a portion of the spring chamber axially faces the at least a portion of the noise generation space that is at least partially enclosed by the noise abatement ring.

12. A system as claimed in claim 11, wherein the entire spring chamber axially faces the at least a portion of the noise generation space that is at least partially enclosed by the noise abatement ring.

13. A system as claimed in claim 12, wherein the pulley has a belt engagement surface that is positioned and shaped to engage an accessory drive belt so as to drive the accessory drive belt via the crankshaft, a first pulley flange on a first side of the belt engagement surface, and a second pulley flange on a second side of the belt engagement surface, wherein the noise abatement ring extends from the first pulley flange.

14. A system for reducing torsional vibrations for a rotary shaft in a vehicle, comprising:
an isolation device mountable on the rotary shaft, and which is rotatable thereon about an axis, wherein the isolation device includes a shaft adapter that is mounted to the rotary shaft, a rotary transfer member that is rotatably mounted to the shaft adapter and which is shaped to engage one of an endless drive member or a gear, and at least one isolation spring that resiliently transfers torque between the pulley and the shaft adapter;
a torsional vibration damper that is mountable to the rotary shaft, wherein a noise generation space extends axially between the isolation device and the torsional vibration damper; and
a noise abatement ring that extends axially from one of the isolation device and the torsional vibration damper towards the other of the isolation device and the torsional vibration damper, and at least partially radially encloses at least a portion of the noise generation space, wherein the noise abatement ring extends to within a selected distance of the other of the isolation device and the torsional vibration damper.
